(19) United States
(12) Patent Application Publication
(10) Pub. No.: US 2003/0179382 A1
(43) Pub. Date: Sep. 25, 2003

(54) Use of electronic speckle interferometry for defect detection in fabricated devices

(75) Inventors: Michael L. Peterson JR., Orono, ME (US); Anthony DiLeo, Westford, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Millipore Corporation, Billerica, MA

(21) Appl. No.: 10/358,116

(22) Filed: Feb. 3, 2003

Related U.S. Application Data
(60) Provisional application No. 60/354,754, filed on Feb. 5, 2002.

(51) Int. Cl. G01B 9/02

(52) U.S. Cl. 356/502

(57) ABSTRACT

Electronic speckle interferometry is used to detect submicron-sized indication in fabricated devices, such as membranes. Indications include indentations, deformations or defects. For example, disbonds between a membrane surface and a bonded edge surface can be detected. An acoustic source can be used to excite the membrane. The acoustic source can produce a sine wave to vibrate the membrane. An interference image of the membrane is created to show whether submicron-sized defects exist in the membrane.

### RELATED APPLICATIONS

This application claims the benefit of U.S. Provisional Application No. 60/354,754, filed Feb. 5, 2002. The entire teachings of the above application is incorporated herein by reference.

### BACKGROUND OF THE INVENTION

Interferometry is a technique used to measure the out-of-plane deformation of a test sample. In the interferometry process, two images are taken of an object and optically combined. A first image is taken while the sample is in an unstressed state while a second image is taken while the sample is in a stressed state. A combination of the images forms an interference pattern of the sample that can be used to identify defects in the test sample. Interferometry has been used to determine the presence of relatively large defects in structures such as tires and honeycomb structures used in aircraft.

Stressing of a sample during the interferometry process has been performed by vibrational excitation of the sample. One method for vibrating a sample is through direct mechanical coupling of a vibrational source to the sample. However, when detecting defects having dimensions of about 0.125 inches or smaller, the technique has a disadvantage in that excitation of the entire object is required. For the large object typically tested, the greater the weight of the test object, the greater the energy required to vibrate the object. Acoustic excitation of a sample has also been used as a method of vibrating samples. Acoustic excitation has been used for large and heavy samples which would otherwise be difficult to vibrate using a mechanical coupling.

### SUMMARY OF THE INVENTION

An embodiment of the invention relates to a method for detecting submicron sized defects in a fabricated device, such as a membrane, a filter, or a device containing a thin film, for example. The method includes the steps of deforming the fabricated device using an acoustic source, forming an interference image of the fabricated device, and detecting whether a submicron-sized defect is present in the fabricated device.

Prior to testing the fabricated device, the fabricated device can be placed in proximity to the acoustic source. The fabricated device can also be secured within a docking station in proximity to the acoustic source prior to testing. During the testing, the fabricated device can be deformed by energy such as sinusoidal sound waves, white noise, and pseudo-Gaussian noise.

Further, the method can include forming an interference image by splitting a beam of coherent light into a reference beam and a test beam. The test beam is directed toward the fabricated device and the reference beam is directed toward a phase shifting mirror. The test beam reflected from the fabricated device and the reference beam reflected from the phase shifting mirror are then be combined. The phase shift mirror can be adjusted to adjust a path length of the reference beam.

When an interference image of the fabricated device has been obtained, the interference image of the fabricated device can be compared with an interference image of a defect-free fabricated device to detect the presence of submicron-sized defects within the fabricated device.

Another embodiment of the invention relates to a method for detecting submicron-sized defects in a membrane. This includes the steps of deforming the membrane using an acoustic source, forming an interference image of the membrane, and detecting whether a submicron-sized defect is present in the membrane.

Another embodiment of the invention relates to a method for manufacturing a membrane. This method includes attaching a membrane to a bonding edge and securing the membrane within a docking station located in proximity to an acoustic source. The membrane is then deformed using the acoustic source. An interference image of the membrane is then formed and the presence of a submicron-sized defect between the membrane and the bonding edge can then be detected.

Another embodiment of the invention relates to a defect detection system. The system includes a coherent light source and a beam splitter optically aligned with the light source. The beam splitter receives light from the light source and divides the light into a reference beam and a test beam. The system also includes a vibration device for vibrating a test sample during reflection of the test beam by the test sample. A camera receives both the reference beam and the test beam reflected from the test sample to form a shearogram image. A computer is electronically coupled to the camera. The computer receives the shearogram image from the camera and compares the received shearogram image with a reference shearogram image.

The coherent light source can be a laser source. The system can also include an acousto-optic modulator optically aligned with the light source where the acousto-optic modulator allows or prevents light to travel from the light source. An aperture can also be optically aligned with the light source such that the aperture collimates light from the light source. A first mirror can be positioned between the light source and the camera where the first mirror directs the reference beam from the light source and toward the camera.

The vibration device in the system can include an acoustic source, such as a speaker coupled to a function generator. The function generator can drive the speaker with a sine wave. The camera of the system can be a charge-coupled device (CCD) camera. A display can be coupled to the camera where the display displays an interference pattern of a test sample. A pulse synchronizer can be electronically coupled to the coherent light source, the vibration device, and the camera. The pulse synchronizer acts to synchronize the operation of the coherent light source, the vibration device, and the camera. A combiner can be mounted in proximity to the camera where the combiner combines the test beam and the reference beam into a composite beam.

The system can also include a phase shifting mirror for adjusting the path length of the reference beam such that the path length of the reference beam is approximately equal to the path length of the test beam. The system can also include a first lens optically aligned with the reference beam for expanding the reference beam and/or a second lens optically aligned with the test beam for expanding the test beam. A docking station can be mounted in proximity to the vibration device to secure a sample for testing within the system.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention. All parts and percentages are by weight unless otherwise indicated.

FIG. 1 illustrates a system for detecting defects in a membrane.

FIG. 2 illustrates an alternate design for a membrane defect detecting system.

FIGS. 3 and 4 illustrate membranes having defects.

FIGS. 5A and 5B illustrate excitations of a filter in a first mode.

FIGS. 6A and 6B illustrate excitation of a filter in a second mode.

FIG. 7 illustrates shearographic image of a membrane having a disbond along the edge of the membrane.

FIG. 8 illustrates a shearographic image of a membrane having a wrinkle along its surface.

### DETAILED DESCRIPTION OF THE INVENTION

A description of preferred embodiments of the invention follows.

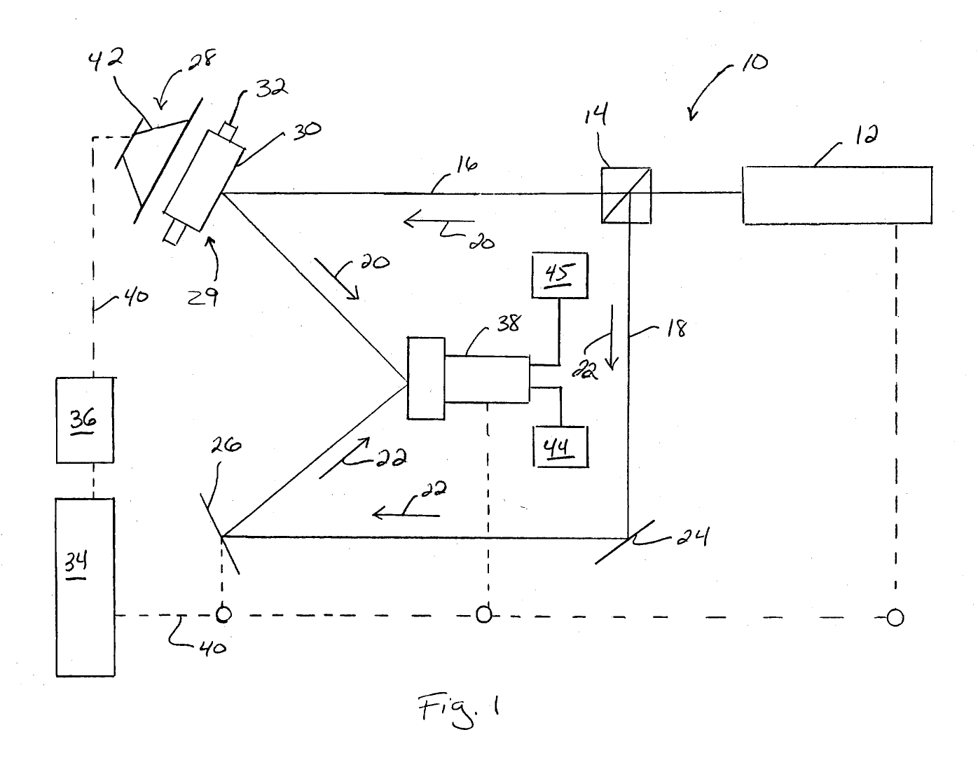

FIG. 1 illustrates a defect detection system, given generally as 10. The system is an electronic speckle interferometry system used to detect submicron sized indications, such as indentations, deformations, or defects, within a fabricated device 29, such as a membrane 30, a filter, or a device containing a thin film. Electronic speckle interferometry is used to detect the slope of the deformations in the membrane 30 during excitation by a vibration source. Electronic speckle interferometry does not detect deformations in the membrane 30 itself. As a membrane 30 vibrates, the slope of the surface of the membrane 30 changes over time. Defects within the membrane 30 cause the membrane 30 to vibrate, in the area of the defect, at a frequency different from that of the rest of the membrane 30. This can be detected by electronic speckle interferometry as a change in slope of the surface of the membrane 30.

The defect detection system 10 includes a coherent light source 12, which can be for example a laser light source, that provides light to a sample to be tested. A beam splitter 14 is optically aligned with the coherent light source 12. The beam splitter 14 divides the beam of light from the light source 12 into two separate beams which include a test beam 16 and a reference beam 18. As shown in FIG. 1, the paths of the test beam 16 and reference beam 18 are separate. The test beam 16 travels within the defect detection system 10 along path 20 while the reference beam 18 travels along path 22. Preferably, the length of the test beam path 20 is equal to the length of the reference beam path 22.

The defect detection system 10 also includes a vibration device 28. The vibration device 28 can include a speaker 42 or any acoustic source to propagate sound waves perpendicular to a surface of the membrane 30. The speaker 42 is driven by a device driver 36. Preferably, the device driver 36 is a function generator which can cause the speaker 42 to vibrate according to a chosen wave form pattern. For example, the function generator can generate a sine wave pattern, thereby causing the speaker 42 to vibrate in a sinusoidal pattern. The function generator can also produce a white noise, a pseudo-Gaussian noise pattern, or a broadband excitation pattern, for example, to drive the speaker 42. Preferably, the speaker 42 produces a frequency within the audible range of frequencies.

The defect detection system 10 includes a camera 38. Preferably, the camera 38 is a CCD camera. The camera 38 receives the test beam 16, as reflected from a sample 30 and the reference beam 18, as reflected from a phase shift mirror 26, to form a shearogram image. The camera 38 can be connected to a computer 44 to collect images from the combined test beam 16 and reference beam 18. These images can be stored and averaged within the computer 44 to form a shearogram image. Alternately, the camera 38 can be connected to a frame grabber to collect images from the camera. The camera 38 can also be connected to a display or monitor 45 to display a visual image of the shearogram image.

As illustrated, the reference beam 18 is directed from the beam splitter 14 to a first mirror 24 which, in turn, redirects the reference beam 18 to the phase shift mirror 26. The phase shift mirror 26 is used to adjust the length of path 22 of the reference beam 18 in the system 10 in order to eliminate any pre-existing interference between the test beam 16 and the reference beam 18.

Prior to testing a membrane 30, the test beam 16 and the reference beam 18 have to be in-phase relative to each other. A difference in the path length between the test beam 16 and the reference beam 18 can force the beams 16, 18 out-of-phase relative to each other. Variability in the path length of the test beam 16 can be created by the positional location of a membrane 30 within the system 10. For example, when the system 10 is used to test multiple membranes 30, the positional location of each of the membranes 30 within the system can vary, thereby creating variability in the path length of the test beam 16. This variability in path length can move the test beam 16 and the reference beam out-of-phase relative to each other.

In order to ensure that the path lengths between the beams 16, 18 are equivalent, the phase shift mirror 26 is used, prior to testing the membrane 30, to adjust the path length 22 of the reference beam 18 relative to the test beam 16. Manipulation of the phase shift mirror 26 effectively “zeroes” or calibrates the system 10 to ensure that, prior to testing, the test beam 16 is in-phase with the reference beam 18. The phase shift mirror 26 eliminates pre-existing interference between the test beam 16 and the reference beam 18, such as caused by positioning of the membrane 30 within the system 10, for example.

The defect detection system 10 also includes a holder 32 or docking station for the membrane 30. The holder 32 is located proximate to the vibration device 28 and is optically aligned with the test beam 16 traveling along path 20 from the beam splitter 14. The holder 32 secures the membrane 30 within the detection system 10 during testing of the membrane 30. The holder 32 can be incorporated as part of an automated system used in the manufacture of the membrane 30. For example, when a membrane 30 is manufactured, defect testing in the membrane 30 can be performed prior to packaging of the membrane 30 for shipment. The holder 32 can be included at the end of a manufacturing assembly line such that upon formation of the final membrane 30, the membrane 30 is transported and secured in the holder 32. Once in the holder 32, testing the membrane 30 for defects can be accomplished using the defect detection system 10. With such a system, each membrane 30 from the assembly process can be tested prior to shipment.

The defect detection system 10 also includes a pulse synchronizer 34. The pulse synchronizer 34 is electrically connected to the device driver 36, the phase shift mirror 26, the camera 38, and the light source 12. The connections are formed using electrical connectors 40. The pulse synchronizer 34 is employed to synchronize the operation of the driver 36, phase shift mirror 26, camera 38 and laser 12. To operate the pulse synchronizer 34, the pulse synchronizer 34 generates a high signal, as in a transistor-transistor logic device. The pulse synchronizer 34 then causes the device driver 36 to send a signal to the vibration device 28 causing the device 28 to vibrate. The vibrations of the device 28 are then transmitted to the membrane 30, thereby causing the membrane 30 to vibrate. The pulse synchronizer 34 simultaneously causes the light source 12 to engage an “on” mode of operation, thereby allowing light to travel from the light source 12 to the membrane 30. The light is then reflected from the membrane 30 and travels towards the camera 38. The pulse synchronizer 34 also actuates the phase shift mirror 26 to allow the reference beam 18 to travel toward the camera 38. The pulse synchronizer 34 also simultaneously places the camera 38 in an “on” or triggered mode of operation, thereby allowing the reference beam 18 and the test beam 16 reflected from the membrane 30 to be captured by the camera 38.

During testing, the membrane 30 is excited by the vibration device 28. The beam splitter 14 divides light from the light source 12 into a test beam 16 and a reference beam 18. The test beam 16 is directed toward the vibrating membrane 30, while the reference beam 18 is directed toward a camera 38. The test beam 16 is reflected from the membrane 30 and directed toward the camera 38. If the test beam 16 undergoes a change as caused by the vibration of the membrane 30, the phase of the test beam 16 changes. If there is a difference in phase between the test beam 16 and the reference beam 18, combination of the beams 16, 18 create an interference pattern. This interference pattern is used to create a shearogram image.

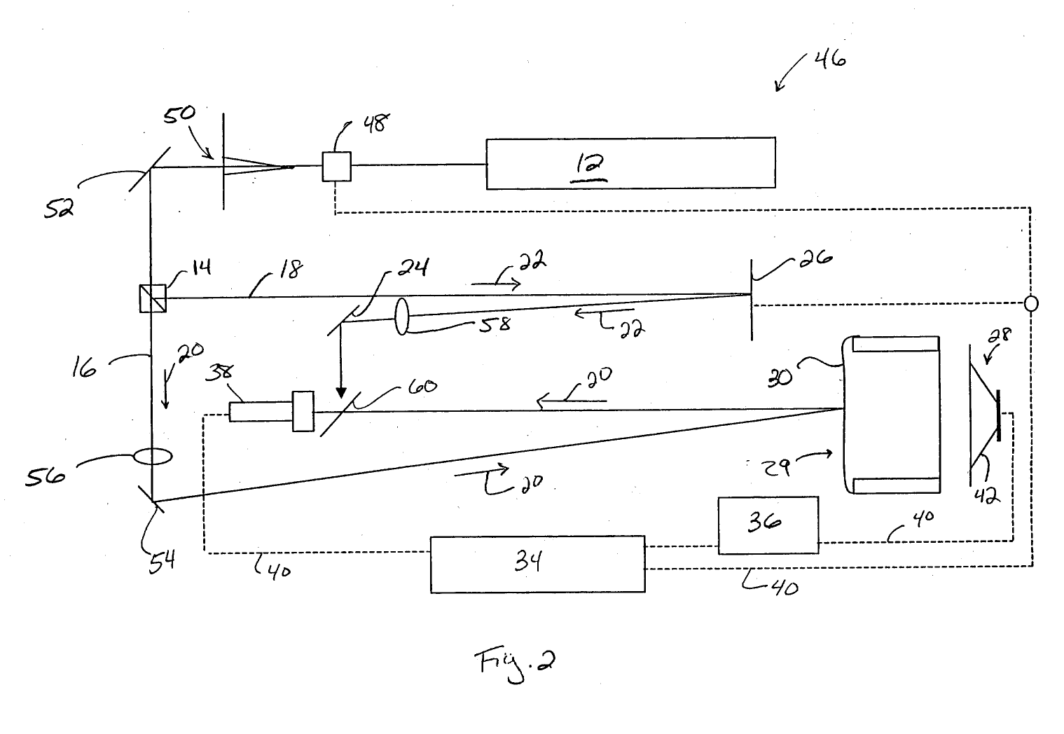

FIG. 2 shows an alternate design for a fabricated device defect detection system 46. The system 46 includes an acousto-optic modulator 48 that is optically aligned with the light source 12. The fabricated device 29 can be a membrane 30, for example. The modulator 48 is also electrically connected by means of an electrical connector 40 to the pulse synchronizer 34.

The acousto-optic modulator 48 acts as a shutter for the light source 12. As is illustrated in FIG. 2, the light source 12 is not connected to the pulse synchronizer 34. Therefore, when the membrane 30, is tested, the light source 12 is placed in an “on” mode of operation and remains in a continuous “on” mode of operation. The acousto-optic modulator 48 as controlled by the pulse synchronizer 34 acts as a timing circuit for the light source 12 to synchronize transmission of the light from the light source with the acoustic response of the membrane 30. The acousto-optic modulator 48 is actuated by the pulse synchronizer 34 to allow light from the light source 12 into the system 46 when the membrane 30 is at its maximum deformation corresponding to the acoustic excitation. The pulse synchronizer 34 simultaneously activates the acousto-optic modulator 48, the camera 38 and the driver 36. When actuated, the pulse synchronizer 34 activates the acousto-optic modulator 48 while simultaneously causing the driver 36 to acoustically excite the membrane 30. The acousto-optic modulator 48 is timed to allow light from the light source 12 into the system 46 when the membrane 30 reaches its maximum deformation. Preferably, the maximum deformation of the membrane 30 occurs when the surface of the membrane 30 is bowed toward the camera 38. The camera 38 then receives light reflected from the membrane 30 at its maximum deformation.

The defect detection system 46 also includes an aperture 50. The aperture 50 is optically aligned with the acousto-optic modulator 48 and acts to collimate the light from the light source 12 into a focused beam. Light from the aperture 50 is directed towards a second mirror 52 which, in turn, directs the light from the light source 12 towards the beam splitter 14.

The reference beam 18 from the beam splitter 14 travels along path 22 to the phase shift mirror 26. From the phase shift mirror 26, the reference beam 18 is directed toward a reference beam expander 58. The reference beam expander 58 can be a lens, for example. From the expander 58, the reference beam 18 is directed to the first mirror 24.

The test beam 16 from the beam splitter 14 travels to a test beam expander 56. The test beam expander 56 can be a lens, for example. Light from the expander 56 travels to a third mirror 54 which directs the test beam 16 towards the membrane 30.

The combiner 60 acts to combine the test beam 16 with the reference beam 18 prior to directing a composite beam into the camera 38. The combiner 60 is located in optical alignment with the camera 38. The reference beam 18 is directed toward the combiner 60 from the first mirror 24. The test beam 16 is reflected from the membrane 30 and is directed along path 20 towards the combiner 60. The combiner 60 effectively adds the test beam 16 to the reference beam 18 to form the composite beam. The addition of the beams 16, 18 creates a shearogram image that can be used to show defects in the membrane 30. While addition of the beams 16, 18 can be performed, subtraction of the test beam 16 from the reference beam 18 can also be performed.

It should be noted that while a test beam 16 and a reference beam 18 are used to create a shearogram image, it is within the scope of the invention to use two laterally displaced images of the same object to form a shearogram image.

The defect detection system is used to detect submicron sized defects in a membrane. The system can be used to detect edge bond defects in membranes 30 having an edge mounted along the circumference of the membrane. FIG. 3 illustrates a membrane 100 having a filtering surface or area 104 and an edge portion 102. The edge portion 102 can be formed from a plastic material, for example, and located around the circumference of the filtering surface 104. Also shown in FIG. 3 is a disbond 106 between the bonded edge 102 and the filtering surface 104. Such disbonds 106 can occur during the manufacturing process. During manufacture, the edge portion 102 is bonded to the filter surface 104, such as by using a heat seal, vibration welding, or adhesive. During the bonding process, defects can be created. Such defects can occur when a portion of the interface between the filter surface 104 and the edge 102 is not properly heated or does not properly combine. Also, such defects can occur when a portion of the filtering surface 104 folds on itself prior to bonding of the edge 102 to the filtering surface 104. Note that while the defect shown in FIG. 3 is relatively large, this is for illustrative purposes only. The actual size of the defects between the edge 102 and the filtering surface 104 are on the submicron level.

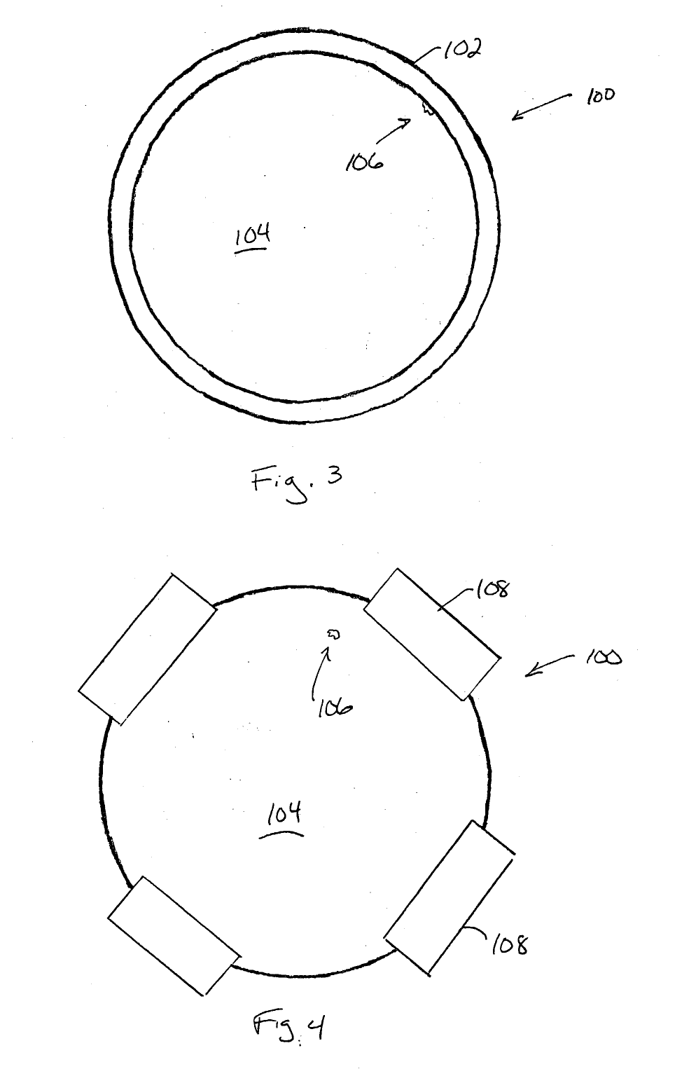

The defect detection system can also be used on membranes that are not fabricated to include a bonded edge. For example, FIG. 4 illustrates a membrane 100 having a membrane filtering surface 104 without a bonded edge. In order to secure the membrane 100 within the defect detection system, securing portions 108 can be used to hold the membrane 100. With such a configuration, a defect 106 located in the filtering surface 104 can be determined using the defect detection system. Again, the size defect 106 is shown for illustrative purposes only as actual defects are often on the sub-micron level.

Returning to FIG. 1, during the testing process, energy, such as a sound wave, is directed from the vibration device 28 towards a membrane 30. The energy or sound wave causes the membrane to deform using a signal such as a sine wave. The membrane 30 vibrates at a frequency with a pattern determined by the vibration source. The shape of the membrane 30 changes as a function of the radius of the membrane 30 and as a function of time.

All objects have a natural frequency of oscillation. The natural or resonant frequency depends upon the material and physical properties of the object. Vibrating an object at frequencies that are multiples of the resonant frequency, for example 2×, 3× or 4× the resonant frequency, produces different modes of vibration of the object. In the present system, a speaker 42 induces a vibration in the membrane 30 using a sine wave having a frequency based upon the resonance frequency of the particular membrane being tested. Different multiples of the resonance frequency can be used to produce different modes of vibration in the membrane 30 at frequencies that are not associated with natural modes. The modes are superposed to create distinct deformations.

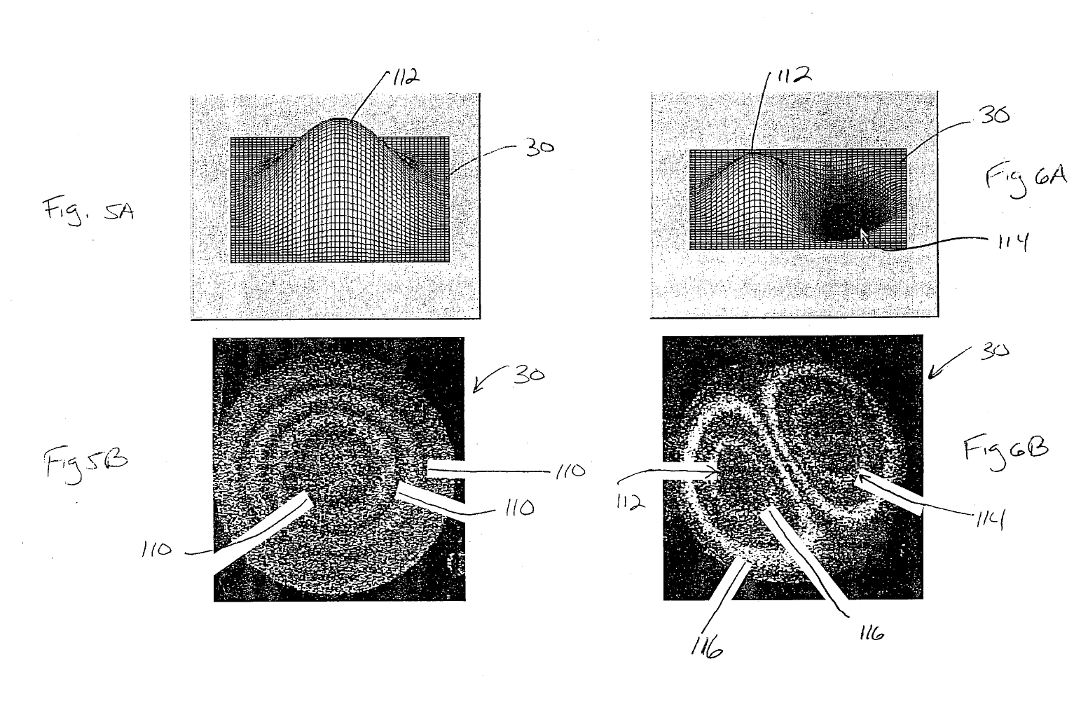

FIGS. 5A and 5B illustrate the excitation of a membrane at its resonance frequency. Such an excitation is defined as a first mode excitation. To obtain a first mode vibration in the membrane 30, the speaker pulses a sine wave at the membrane 30 where the frequency of the sine wave is based upon the resonance frequency of the membrane 30. FIG. 5A shows a perspective view of the membrane 30 at its maximum deformation caused by the sound wave. With a first mode excitation, the membrane 30 forms a single crest, as is illustrated in FIG. 5A, or a single trough, not shown, depending upon the portion of the sine wave cycle that excites the membrane. FIG. 5B illustrates a top view of the membrane 30 during the first mode excitation and shows a plurality of concentric rings 110. The rings 110 illustrate the deformation of the membrane 30 over time and show the dependence of the deformation on the radius of the membrane 30.

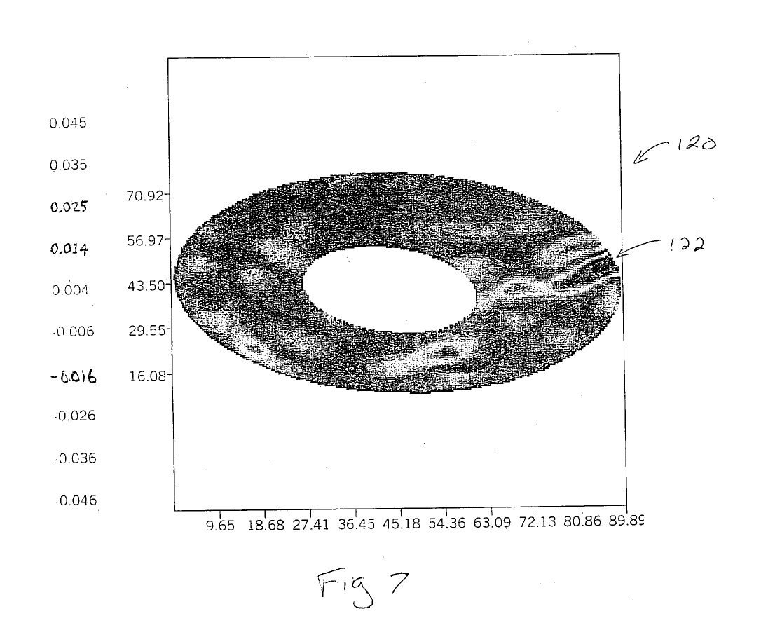

FIGS. 6A and 6B illustrate the excitation of the membrane 30 at a first multiple of its resonance frequency. Such an excitation is defined as a second mode excitation. For example, vibrating a membrane 30 with a sine wave at a resonance frequency of 100 Hz can produce a first mode excitation in the membrane 30. A sine wave having a frequency of 200 Hz, twice the frequency of the resonance frequency, can be used to produce a second mode excitation in the membrane 30. The second mode excitation produces a crest 112 and a trough 114 in the membrane. FIG. 6A shows a perspective view of the membrane 30 at its maximum deformation caused by the sound wave during a second mode excitation. FIG. 6B illustrates a top view of the membrane 30 during the second mode excitation and shows a plurality of concentric rings 116. The rings 116 illustrate the deformation of the membrane 30 over time and show the dependence of the deformation on the radius of the membrane.

Increasing the frequency of the sine wave by multiples of a resonance frequency can produce multiple excitation modes. For example, generating a sine wave at triple the frequency of a resonance frequency creates a third mode of excitation. In order to detect disbonds between the membrane surface and the bonded edge of the membrane 30, vibrational excitement of the membrane 30 should create a sharp slope between the membrane surface and the bonded edge because electronic speckle interferometry detects the slope of deformation in an object and not the deformation of the object itself. A sharp slope between the membrane surface and the bonded edge can accurately determine the presence of disbonds. In order to create a sharp slope at the edge of the membrane 30, modes of excitation beyond a second mode, such as a third, fourth or fifth mode, can be used to create a plurality of nodes on the membrane 30 and a sharp slope between the membrane surface and the edge bond. In general, the higher the frequencies used to vibrate the membrane 30, the smaller the defect that can be detected in the membrane 30. However, vibration of the membrane at increased frequencies can produce a “blurred” shearogram image. Preferably, a vibration frequency is chosen that is high enough to detect the defects in the membrane 30, but not so high as to create a blurred pattern on the membrane 30 due to spatial sampling constraints on the apparatus.

To create a shearogram image of the membrane during excitation, multiple images of the membrane are taken during the vibration process. The images are taken when the membrane is maximally deformed by the vibration source. The test beam 16 as reflected from the membrane 30 is combined with the reference beam 18 to form a sheared image.

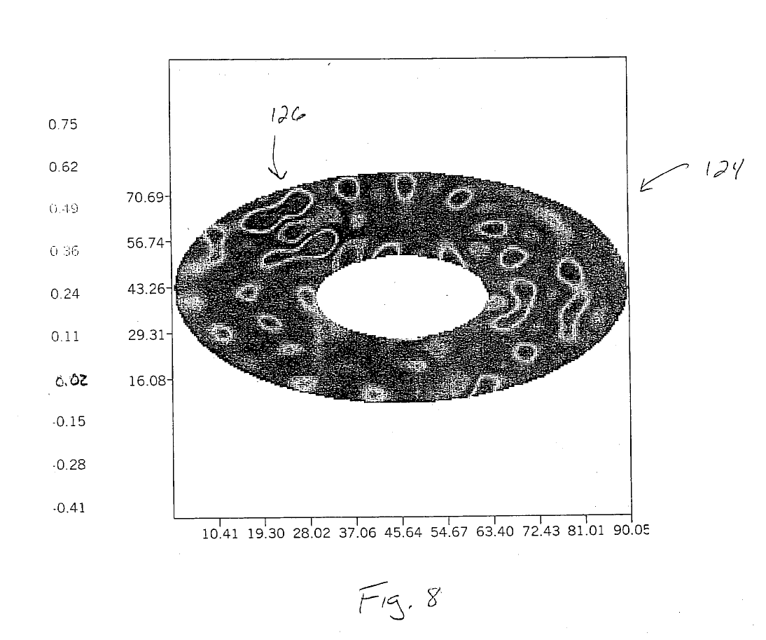

FIG. 7 illustrates a shearogram image 120 for a membrane having a disbond between the membrane surface and an edge bond of the membrane. The disbond 122, as illustrated, appears as a dark or “hot” spot on the shearogram image. The shearogram was produced with the filter being excited at a frequency of 1.41 kHz.

FIG. 8 illustrates a shearogram image 124 for a membrane having a wrinkle 126 in the surface of the membrane. The shearogram 124 was produced with the membrane being vibrated at a frequency of 4.08 kHz. The wrinkle 126 is indicated by a dark area or a “hot spot” located in the upper left hand corner of the shearogram 124.

In order to classify the type of defect found in a fabricated device or membrane, the shearogram image produced by the system is compared to a reference shearogram image, such as an image of a known defect free fabricated device or membrane. The comparison can be done using signal processing, such as by using the computer 44, to compare the average shearogram image with a shearogram image of the defect free membrane. The comparison can allow the detection of the presence of defects within the membrane or fabricated device.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for detecting submicron-sized defects in a fabricated device comprising:
a) deforming the fabricated device using an acoustic source;
b) forming an interference image of the fabricated device; and
c) detecting whether a submicron-sized defect is present in the fabricated device.

2. The method of claim 1 further comprising placing the fabricated device in proximity to the acoustic source.

3. The method of claim 2 further comprising securing the fabricated device within a docking station in proximity to the acoustic source.

4. The method of claim 1 wherein the step of forming an interference image comprises:
a) splitting a beam of coherent light into a reference beam and a test beam;
b) directing the test beam toward the fabricated device;
c) directing the reference beam toward a phase shifting mirror; and
d) combining the test beam reflected from the fabricated device and the reference beam reflected from the phase shifting mirror.

5. The method of claim 4 further comprising adjusting the phase shifting mirror to place the reference beam in-phase with the test beam.

6. The method of claim 1 further comprising deforming the fabricated device using at least one type of energy selected from the group consisting of sinusoidal sound waves, white noise, and psuedo-Gaussian noise.

7. The method of claim 6 further comprising deforming the fabricated device using a sinusoidal sound wave.

8. The method of claim 1 further comprising comparing the interference image of the fabricated device with an interference image of a defect-free fabricated device to detect the presence of submicron-sized defects within the fabricated device.

9. A method for detecting submicron-sized defects in a membrane comprising:
a) deforming the membrane using an acoustic source;
b) forming an interference image of the membrane; and
c) detecting whether a submicron-sized defect is present in the membrane.

10. The method of claim 9 further comprising placing the membrane in proximity to the acoustic source.

11. The method of claim 10 further comprising securing the membrane within a docking station in proximity to the acoustic source.

12. The method of claim 9 wherein the step of forming an interference image comprises:
a) splitting a beam of coherent light into a reference beam and a test beam;
b) directing the test beam toward the membrane;
c) directing the reference beam toward a phase shifting mirror; and
d) combining the test beam reflected from the membrane and the reference beam reflected from the phase shifting mirror.

13. The method of claim 12 further comprising adjusting the phase shifting mirror to place the reference beam in-phase with the test beam.

14. The method of claim 9 further comprising deforming the fabricated device using at least one type of energy selected from the group consisting of sinusoidal sound waves, white noise, and psuedo-Gaussian noise.

15. The method of claim 14 further comprising deforming the membrane using a sinusoidal sound wave.

16. The method of claim 9 further comprising comparing the interference image of the membrane with an interference image of a defect-free membrane to detect the presence of submicron-sized defects within the membrane.

17. A method for manufacturing a membrane comprising:
a) attaching a membrane to a bonding edge;
b) securing the membrane within a docking station located in proximity to an acoustic source;
c) deforming the membrane using the acoustic source;
d) forming an interference image of the membrane; and
e) determining whether a submicron-sized defect is present between the membrane and the bonding edge.

18. A defect detection system comprising:
a) a coherent light source;
b) a beam splitter optically aligned with the light source, the beam splitter receiving light from the light source and dividing the light into a reference beam and a test beam;
c) a vibration device for vibrating a test sample during reflection of the test beam by the test sample;
d) a camera for receiving both the reference beam from the beam splitter and the test beam reflected from the test sample to form a shearogram image; and
e) a computer electronically coupled to the camera, the computer receiving the shearogram image from the camera and comparing the received shearogram image with a reference shearogram image.

19. The system of claim 18 wherein the coherent light source comprises a laser source.

20. The system of claim 18 further comprising an acousto-optic modulator optically aligned with the light source, the acousto-optic modulator allowing or preventing light to travel from the light source.

21. The system of claim 18 further comprising an aperture optically aligned with the light source, the aperture collimating light from the light source.

22. The system of claim 18 further comprising a first mirror positioned between the light source and the camera, the first mirror directing the reference beam from the light source and toward the camera.

23. The system of claim 18 wherein the vibration device comprises an acoustic source.

24. The system of claim 23 wherein the acoustic source comprises a speaker coupled to a function generator.

25. The system of claim 24 wherein the function generator drives the speaker with a sine wave.

26. The system of claim 18 wherein the camera is a charge-coupled device camera.

27. The system of claim 18 further comprising a display coupled to the camera, the display displaying an interference pattern of a test sample.

28. The system of claim 18 comprising a phase shifting mirror for adjusting the path length of the reference beam such that the path length of the reference beam is approximately equal to the path length of the test beam.

29. The system of claim 18 further comprising a pulse synchronizer electronically coupled to the coherent light source, the vibration device, and the camera, the pulse synchronizer synchronizing the operation of the coherent light source, the vibration device, and the camera.

30. The system of claim 18 further comprising a first lens optically aligned with the reference beam for expanding the reference beam.

31. The system of claim 18 further comprising a second lens optically aligned with the test beam for expanding the test beam.

32. The system of claim 18 further comprising a docking station mounted in proximity to the vibration device, the docking station securing a sample for testing.

33. The system of claim 18 further comprising a combiner mounted in proximity to the camera, the combiner combining the test beam and the reference beam into a composite beam.
